(19) United States
(12) Patent Application Publication
(10) Pub. No.: US 2026/0030969 A1
(43) Pub. Date: Jan. 29, 2026

(54) METHOD AND SYSTEM FOR DETERMINING AT-RISK AREAS AROUND AN AIRCRAFT

(71) Applicant: AIRBUS OPERATIONS SAS, Toulouse (FR)

(72) Inventor: Matthieu LACAMPAGNE, Toulouse (FR)

(73) Assignee: AIRBUS OPERATIONS SAS, Toulouse (FR)

(21) Appl. No.: 19/274,185

(22) Filed: Jul. 18, 2025

(30) Foreign Application Priority Data
Jul. 25, 2024 (FR) 2408244

(51) Int. Cl. G08B 21/22; G08B 21/16

(52) U.S. Cl. CPC G08B 21/22; G08B 21/16

(57) ABSTRACT

A method for determining at least one at-risk area around an aircraft during an execution of ground operations around and/or on the aircraft. This method includes, upon receipt of a request to determine at least one at-risk area, obtaining first information which is representative of at least one element which is a source of at least one risk, and operational context information which is representative of an operational context of the aircraft during said ground operations, determining said at-risk area and location thereof, then transmitting said location to indicate a presence of at least one at-risk area in said location to personnel operating on and/or around the aircraft during said ground operations. It is possible to identify one or more at-risk areas and to locate them in an area around the aircraft for one or more risks associated with various hazards which can be encountered during ground operations.

### TECHNICAL FIELD

The technical field relates to a method and a system for determining at-risk areas in an area around an aircraft during the ground phases. In particular, the present disclosure relates to identifying and then locating these at-risk areas in order to indicate them to the personnel operating around and/or on the aircraft during the ground phases.

### PRIOR ART

The development of new technologies in the field of aviation also causes new risks (e.g. risk of explosion, fire, jet blast, etc.) to appear for personnel, notably ground personnel, operating around and/or on the aircraft during the ground phases (e.g. taxiing, parking, refuelling, etc.).

In order to ensure the safety of personnel, and to prevent any risk of hazard, personnel must possess particular qualifications, as well as specific dedicated equipment, in order to be allowed to enter areas referred to as “at-risk” areas in which there is a risk of hazard (e.g. risk of an explosive atmosphere).

However, some of these hazards are not directly visible to or detectable by personnel. This is the case, for example, with the presence of kerosene vapours or the presence of dihydrogen gas in the atmosphere. Thus, it can be difficult for personnel to determine the location and size of these at-risk areas around the aircraft, and therefore to know whether they possess the appropriate qualifications and equipment to operate there.

The situation can be improved. It is, notably, desirable to provide a solution which makes it possible to determine the at-risk areas around the aircraft, as well as their location and, where applicable, their size, in order to be able to indicate them to personnel operating around and/or on the aircraft during the ground phases.

### SUMMARY OF THE INVENTION

A method for determining at least one at-risk area in an area around an aircraft during an execution of ground operations around and/or on the aircraft is proposed here, the risk corresponding to a risk of hazard, inside said at-risk area, for personnel operating around and/or on the aircraft, said method being executed by an at-risk area determination system comprising electronic circuitry, configured to: upon receipt of a request to determine at least one at-risk area:
obtain first information which is representative of at least one element which is a source of at least one risk,
obtain operational context information which is representative of an operational context of the aircraft during said ground operations,
determine, on the basis of said first information and said operational context information, said at-risk area and a location of said at least one at-risk area;
transmit said location of said at least one at-risk area in order to indicate a presence of said at least one at-risk area in said determined location to personnel operating on and/or around the aircraft during said ground operations.

Thus, it is possible to identify one or more at-risk areas for personnel operating around and/or on the aircraft and to locate them in an area around the aircraft for one or more risks associated with various hazards which can be encountered during ground operations. Advantageously, it is possible to warn the ground or flight personnel of the location of these at-risk areas and thus to alert of the need to possess qualifications and equipment which are appropriate for managing the one or more risks of the areas thus identified.

According to one embodiment, the risk corresponds to at least one risk among:
a risk associated with a hazard of an explosive atmosphere linked to the kerosene vapours or to the presence of dihydrogen in the atmosphere;
a risk associated with a “mechanical” hazard linked to the actuation of the movable elements of the aircraft such as a landing gear or a thrust reversal system;
a risk associated with an “engine” hazard linked to a phenomenon of jet blast or ingestion around intake;
a risk associated with an “electrical” hazard linked with an electrical phenomenon around the aircraft.

According to one particular embodiment, said operational context information is obtained on the basis of a selection from a list of operational scenarios comprising at least one scenario.

According to one particular embodiment, said request to determine said at least one at-risk area originates from:
a human-machine interface of a cockpit of said aircraft,
a human-machine interface which is integrated into the aircraft and can be accessed through a hatch made in the fuselage of the aircraft, or
a human-machine interface of a control centre.

According to one particular embodiment, the method further comprises: receiving confirmation of the determination of said at least one at-risk area from: the human-machine interface of the cockpit of the aircraft, the human-machine interface which is integrated into the aircraft and can be accessed through the hatch, or the human-machine interface of the control centre.

According to one particular embodiment, transmitting said location of said at least one at-risk area comprises: transmitting said determined location to equipment on board the aircraft and/or ground support equipment.

According to one particular embodiment, the equipment on board the aircraft and the ground support equipment are chosen from:
laser emitters,
photonic radars, and
sound warning devices.

According to one particular embodiment, the method further comprises: said equipment on board the aircraft and/or the ground support equipment displaying an outline of said at least one at-risk area, or a surface area of said at least one at-risk area.

A system for determining at least one at-risk area in an area around an aircraft during an execution of ground operations around and/or on the aircraft is also proposed here, the risk corresponding to a risk of hazard, inside said at-risk area, for personnel operating around and/or on the aircraft. The at-risk area determination system comprises electronic circuitry, configured to: upon receipt of a request to determine at least one at-risk area:
obtain first information which is representative of at least one element which is a source of at least one risk,
obtain operational context information which is representative of an operational context of the aircraft during said ground operations,
determine, on the basis of said first information and said operational context information, said at-risk area and a location of said at least one at-risk area;
transmit said location of said at least one at-risk area in order to indicate a presence of said at least one at-risk area in said determined location to personnel operating on and/or around the aircraft during said ground operations.

An aircraft comprising a system for determining at-risk areas as described above is also proposed here.

A computer program product, comprising instructions causing the abovementioned method according to any one of its embodiments to be executed by a processor when said instructions are executed by the processor, is also proposed. A storage medium, storing such instructions, is also proposed.

### BRIEF DESCRIPTION OF THE DRAWINGS

The abovementioned features of the invention, as well as others, will become more clearly apparent upon reading the following description of at least one example of an embodiment, said description being given with reference to the appended drawings, among which:

FIG. 1 schematically illustrates, in side view, an aircraft equipped with a system for determining at-risk areas, according to one embodiment;

FIG. 2 schematically illustrates the system for determining at-risk areas of an aircraft, according to one embodiment;

FIG. 3 schematically illustrates one example of a hardware platform which makes it possible to implement, in the form of electronic circuitry, the system for determining at-risk areas of an aircraft, according to one embodiment;

FIG. 4 schematically illustrates various steps of a method for determining at-risk areas, which is executed by the determination system, according to one embodiment;

FIG. 5 schematically illustrates one example of the determination system determining several at-risk areas, according to one embodiment;

FIG. 6 schematically illustrates, in plan view, an aircraft around which at-risk areas have been identified, according to one embodiment;

FIG. 7 schematically illustrates, in plan view, an aircraft around which at-risk areas have been identified, according to another embodiment;

FIG. 8 schematically illustrates, in plan view, an aircraft around which at-risk areas have been identified, according to another embodiment.

### DETAILED DESCRIPTION OF EMBODIMENTS

The general principle of the present disclosure is to determine at-risk areas, that is to say to identify them and then to locate them, in an area around an aircraft during the ground phases (e.g., taxiing, parking, etc.). Notably, the objective of the present disclosure is to alert the personnel operating around and/or on the aircraft during the ground phases to these at-risk areas by indicating them using visual and/or sound markers. It is thus possible to warn the ground personnel (e.g. technicians, operators, etc.) and/or flight personnel of the precise location of these at-risk areas around the aircraft.

The terms “area around an aircraft” and “around an aircraft” refer to a geographical area comprising the location of the aircraft. For example, this “area around an aircraft” extends over a few tens of metres all around the aircraft.

Below, the term “risk” refers to a probability of the occurrence of a hazard (e.g. fire, explosion, accident, electrocution, etc.). Risk can be quantified (e.g. at different levels: high, moderate, low). Thus, an “at-risk area” refers to a geographical area inside which a level of risk of a given hazard can be quantified. Outside the at-risk area, the level of risk of a given hazard is considered to be zero. Consequently, for safety reasons, ground personnel must possess appropriate qualifications and equipment in order to be able to enter an at-risk area and carry out operations (e.g. maintenance operations, refuelling, etc.) there. Otherwise, these personnel cannot be allowed to enter the at-risk area. In one example, for areas at risk of an explosive atmosphere (e.g. linked to the presence of kerosene vapour in the atmosphere), personnel allowed to enter these areas must possess qualifications and equipment dedicated to the management of such a risk.

There are various types of risks associated with various hazards which can be encountered around an aircraft during the ground phases. For example:
a risk associated with a hazard of an explosive atmosphere linked to kerosene vapours or the presence of dihydrogen in the atmosphere;
a risk associated with a “mechanical” hazard linked to the actuation of the movable elements of the aircraft such as the landing gear or the thrust reversal system;
a risk associated with an “engine” hazard linked to the phenomenon of jet blast or ingestion around intake;
a risk associated with an “electrical” hazard linked to the electrical phenomenon around the aircraft, for example in connection with the weather conditions;
etc.

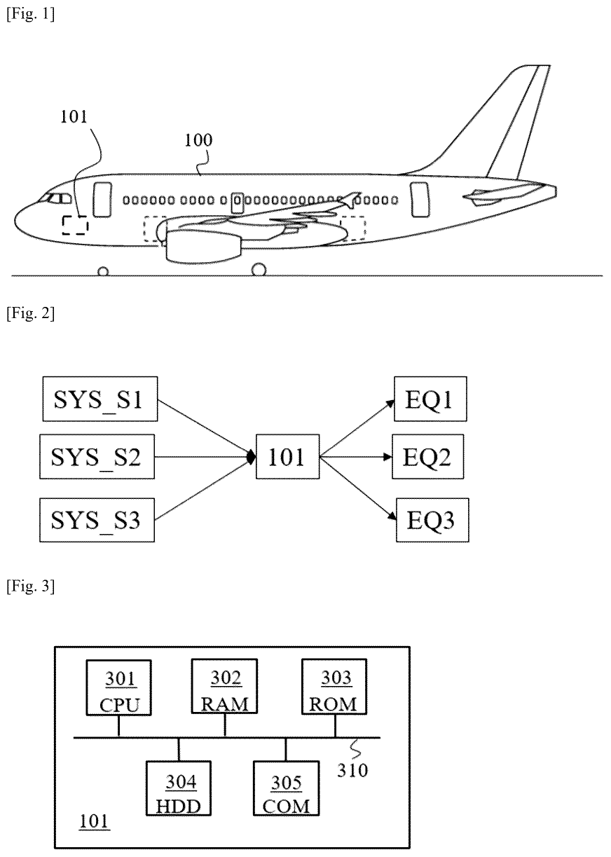

FIG. 1 schematically illustrates, in side view, an aircraft 100 equipped with an at-risk area determination system 101, according to one embodiment.

According to the embodiment of FIG. 1, the at-risk area determination system 101 (also called the determination system 101 below) is an electronic device on board the aircraft 100. For example, the at-risk area determination system 101 forms part of electronic circuitry of the avionics of the aircraft 100.

The determination system 101 is schematically and holistically illustrated in FIG. 2, according to one embodiment.

The determination system 101 is configured to communicate with various avionics systems on board the aircraft 100.

In particular, the determination system 101 is configured to communicate with avionics systems of the aircraft 100 which are configured to monitor a given risk and in particular an element which is a source of this risk (e.g. kerosene vapour in the atmosphere, dihydrogen, etc.). Such systems are also called “risk monitoring systems” SYS_S1, SYS_S2, SYS_S3 below. In particular, these risk monitoring systems SYS_S1, SYS_S2, SYS_S3 are configured to monitor parameters which are characteristic of the element which is the source of the risk (e.g. concentration and mass flow rate of dihydrogen in the atmosphere, etc.). For this purpose, the risk monitoring systems SYS_S1, SYS_S2, SYS_S3 are configured to receive measurements from sensors configured to measure these parameters. The position of the sensors on the aircraft 100 is also transmitted to the risk monitoring systems SYS_S1, SYS_S2, SYS_S3 in order to be able to locate the origin of the risk on the aircraft 100.

The determination system 101 therefore receives, from the various risk monitoring systems SYS_S1, SYS_S2, SYS_S3, first information which is representative of one or more elements which are sources of one or more risks comprising: the nature of a risk monitored by at least some risk monitoring systems SYS_S1, SYS_S2, SYS_S3 (e.g. risk of an explosive atmosphere), the location of the origin of this risk on the aircraft 100 (e.g. ventilation orifice of the aircraft 100), measurements of the parameters which are characteristic of the elements which are sources of this risk (e.g. concentration and mass flow rate of dihydrogen in the atmosphere).

Furthermore, the determination system 101 is configured to receive information referred to as “operational context” information which is representative of an operational context of the aircraft 100 at the moment when a request to determine at-risk areas is received. This operational context information is, for example, provided by the flight personnel according to the operations manuals dedicated to the aircraft 100 via a dedicated human-machine interface in the cockpit. Alternatively, when there are no flight personnel on board the aircraft 100, the operational context information is, for example, provided by the ground personnel according to the operations manuals dedicated to the aircraft 100 via a dedicated human-machine interface in a ground control centre.

According to a first alternative, the determination system 101 is supplied with electric power by the aircraft 100 when an electrical network of the aircraft is powered on. According to a second alternative, the determination system 101 is supplied with electric power by a ground electrical network.

Furthermore, the determination system 101 is configured to interact with items of equipment EQ1, EQ2, EQ3, such as: laser emitters, photonic radars, sound warning devices, etc.

FIG. 3 schematically illustrates one example of a hardware platform which makes it possible to implement, in the form of electronic circuitry, the determination system 101 according to one embodiment.

The hardware platform comprises, connected by a communication bus 310, a central processing unit CPU 301; a random-access memory RAM 302; a read-only memory 303, for example an electrically erasable programmable ROM EEPROM, such as a flash memory; a storage unit, such as a hard disk drive HDD 304 or a storage medium reader, such as an SD (Secure Digital) card reader; and an interface manager COM 305.

Thus, the interface manager COM 305 makes it possible for the determination system 101 to interact with the avionics systems of the aircraft 100, notably the risk monitoring systems SYS_S1, SYS_S2, SYS_S3, and the equipment as described above.

The central processing unit 301 is capable of executing instructions loaded into the random-access memory 302 from the read-only memory 303, from an external memory, from a storage medium (such as an SD card) or from a communication network. When the hardware platform is powered on, the central processing unit 301 is capable of reading instructions from the random-access memory 302 and of executing them. These instructions form a computer program causing all or some of the steps, methods and operating modes described here to be implemented by the central processing unit 301.

All or some of the steps, methods and operating modes described here can thus be implemented in software form by executing a set of instructions by means of a programmable machine, for example a digital signal processor (DSP) or a microcontroller, or be implemented in hardware form by a machine or a dedicated chip or a dedicated chipset, for example a field-programmable gate array (FPGA) or application-specific integrated circuit (ASIC) component. In general, the determination system 101 comprises electronic circuitry adapted and configured to implement all or some of the operating modes, methods and steps described here.

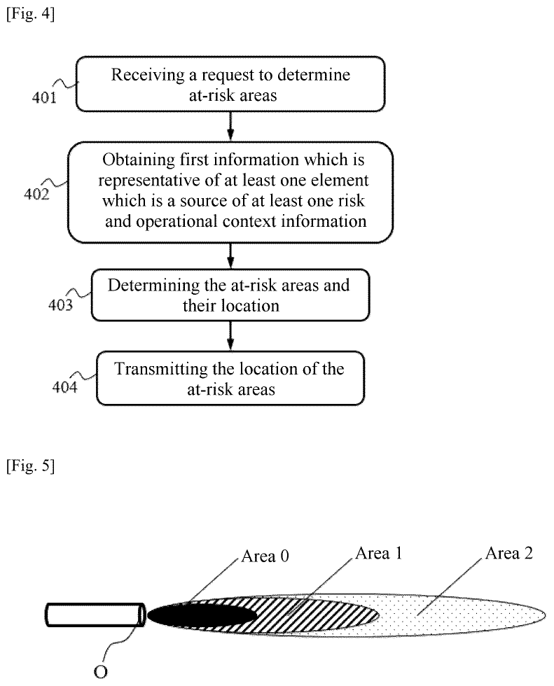

FIG. 4 schematically illustrates various steps of an at-risk area determination method executed by the determination system 101, according to one embodiment.

All or some of this determination method is implemented by the determination system 101 described above.

Before at-risk areas are determined, the determination system 101 is awaiting receipt of a request to determine at-risk areas on the part of the flight personnel or the ground personnel.

During the ground phases of the aircraft 100 (e.g. taxiing, parking, refuelling, etc.), the determination system 101 is activated upon receipt of this request to determine at-risk areas. More generally, the determination system 101 is activated by the flight personnel or the ground personnel with a view to ground operations to be carried out (e.g. maintenance, refuelling, etc.). The objective is to alert the personnel made to operate around and/or on the aircraft 100 during ground operations to the presence of at-risk areas around the aircraft 100.

Thus, during a step 401, the determination system 101 receives, via a human-machine interface, the request to determine at-risk areas. In particular, according to one embodiment, this request is made by flight personnel via a human-machine interface of the cockpit of the aircraft 100.

Alternatively, this request is made by ground personnel via a human-machine interface which is external to the aircraft 100, such as a dedicated human-machine interface of a ground control centre. This is the case, for example, during the first instants when the aircraft 100 is put into service, when there are not yet any flight personnel on board.

Alternatively again, this request is made by ground personnel via a human-machine interface which is integrated into the aircraft and can be accessed by ground personnel by opening a hatch made in the fuselage of the aircraft. In particular, this hatch is located in a lower part of the fuselage so that it can easily be accessed by ground personnel.

According to one embodiment, this request to determine at-risk areas is made by the flight personnel, or the ground personnel, before the ground phases during which ground operations are carried out begin. Alternatively, this request to determine at-risk areas is made when this is only necessary, for example, during specific ground phases during which particular ground operations are carried out (e.g. refuelling of the aircraft 100). Alternatively or additionally, this request to determine at-risk areas is made after authorization by the airport authorities according to the regulations in force.

According to a first embodiment, referred to as “automatic” mode, upon receipt of this request to determine at-risk areas, during a step 402, the determination system 101 obtains:
from various risk monitoring systems SYS_S1, SYS_S2, SYS_S3, first information which is representative of elements which are sources of risks relating to various risks (e.g. risk of an explosive atmosphere, risk of jet blast, etc.);
via the human-machine interface of the cockpit, or from the ground control centre, operational context information about the aircraft 100 (e.g. taxiing, parking, refuelling, etc.).

According to this first embodiment, it is possible to adapt the determination of the corresponding at-risk areas to each risk, depending on the operational context.

According to this first embodiment, during a step 403, the determination system 101 determines, for one or more risks, one or more at-risk areas, as well as their location around the aircraft 100, on the basis of the first information which is representative of elements which are sources of the risks and of the operational context information. Optionally, the determination system 101 furthermore determines a size of each at-risk area the location of which has been determined.

Thus, for the aircraft 100, it is possible to adapt the location and, where applicable, the size of the at-risk areas for one or more risks to all the operational contexts.

In order to illustrate this “automatic” mode, a risk of an explosive atmosphere linked to the emission, into the atmosphere, of kerosene or dihydrogen vapour at the ventilation orifices of the aircraft 100 is considered. The determination system 101 is awaiting a request to determine at-risk areas. The aircraft 100 arrives at a boarding gate of an airport. According to the airport regulations in force, the determination system 101 can be activated only with authorization from the traffic control centre. After authorization from the traffic control centre, the flight personnel present on board the aircraft 100 activate the determination system 101 by requesting, via a human-machine interface of the cockpit of the aircraft 100, that the at-risk areas associated with the hazard of an explosive atmosphere be determined.

Upon receipt of this request, the determination system 101 then obtains:
first information which is representative of elements which are sources of the risk which is associated with an explosive atmosphere. The risk monitoring system dedicated to monitoring the elements which are sources of an explosive atmosphere provides the determination system 101 with the following first information: measurements from sensors for detecting dihydrogen in the atmosphere at the ventilation orifices of the aircraft 100 such as the mass flow of dihydrogen and the concentration of dihydrogen in the atmosphere around the ventilation orifices of the aircraft 100, etc. and
operational context information, provided by the flight personnel.

The determination system 101 then determines the one or more areas at risk of an explosive atmosphere around the aircraft 100, as well as their location.

According to one particular embodiment of this “automatic” mode, the determination system 101 determines various at-risk areas corresponding to a level of risk of a specific hazard, as well as their location. In one example, for a hazard such as an explosive atmosphere linked to the presence of dihydrogen in the atmosphere, the level of risk notably depends on the mass flow rate of dihydrogen measured by a dedicated sensor, for example located at a ventilation orifice of the aircraft 100.

FIG. 5 schematically illustrates various at-risk areas determined by the determination system, according to the example above. The mass flow rate measured (e.g. 3 g/s) by sensors at a ventilation orifice O is transmitted to the determination system 101 by the dedicated risk monitoring system. The determination system 101 then determines three at-risk areas the level of risk of which differs:
Area 0 or upper explosion limit area: area in which the concentration of dihydrogen is too high to detonate (i.e. low level of risk). This area extends, for example, in a radius of 1 m around the ventilation orifice, labelled 0, of the aircraft 100;
Area 1 or area the concentration of dihydrogen of which is between an upper and lower explosion limit: area where the probability of detonation is highest (i.e. high level of risk). This area extends, for example, in a radius of 5 m around the ventilation orifice O of the aircraft 100;
Area 2 or lower explosion limit area: area in which the concentration of dihydrogen is too low to detonate (i.e. low level of risk). This area extends in a radius which is greater than 5 m around the ventilation orifice O of the aircraft 100.

According to a second embodiment, referred to as “manual” mode, a list of scenarios is stored in a memory of the determination system 101 beforehand. A scenario refers to the association between at-risk areas to be determined for a type of risk (e.g. risk of an explosive atmosphere, risk of fire, etc.) with an operational context (e.g. taxiing, parking, refuelling, etc.).

Thus, there are several scenarios for a given operational context depending on the various risks which can be encountered by the ground personnel during the execution of the ground operations. Or, in other words, there are, for a given risk, several operational contexts where it can be encountered by the ground personnel during the execution of the ground operations.

Such a scenario is, for example, “identify the areas at risk of an explosive atmosphere during a refuelling of the aircraft 100”. In another example, a scenario is: “identify the areas at risk of an explosive atmosphere during a parking of the aircraft 100”. A scenario is selected from the list by the flight personnel or by the ground personnel. This list is defined during a phase of designing the determination system 101, for example.

Thus, according to this “manual” mode, during the step 402, the determination system 101 receives, via the human-machine interface of the cockpit, or from the ground control centre, the request to determine at-risk areas, as well as scenario information which is representative of a scenario selected from the stored scenario list.

Then, upon receipt of this request and of this scenario information, during the step 402, the determination system 101 obtains first information which is representative of elements which are sources of risk corresponding to the selected scenario (e.g. risk of an explosive atmosphere).

According to this second embodiment, it is possible to limit the determination of the at-risk areas to a particular operational context and a particular risk. This therefore makes it possible to be limited to the identification and then the indicating of essential at-risk areas. In the event that the airport regulations in force do not allow certain at-risk areas to be indicated by visual and/or sound markers, this “manual” mode makes it possible to select only the operational context and the risk for which the regulations allow the at-risk areas to be indicated.

Then, according to the “manual” mode, during a step 403, the determination system 101 determines, on the basis of the risk information and the scenario information, one or more at-risk areas, as well as their location, for the risk corresponding to the selected scenario. Optionally, the determination system 101 furthermore determines a size of each at-risk area the location of which has been determined.

Thus, for the aircraft 100, it is possible to adapt the location and, where applicable, the size of the at-risk areas for the risk corresponding to the selected scenario.

According to one particular mode of the “manual” mode, the determination system 101 is awaiting the selection of at least one other scenario in order to determine, in parallel, other at-risk areas.

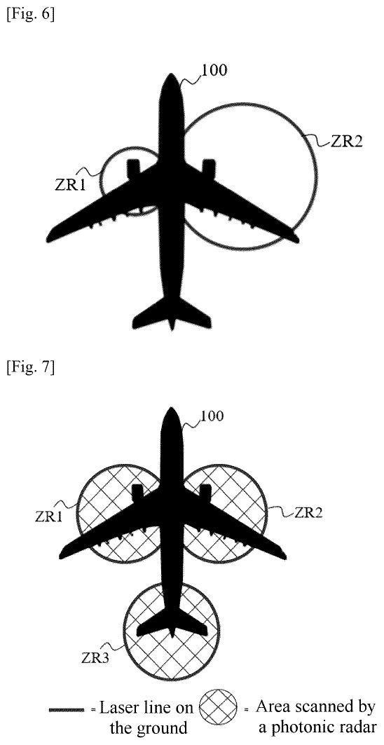

According to one embodiment, the size of the at-risk areas depends on a parameter which is characteristic of the element which is a source of a given risk. FIG. 6 schematically illustrates, in plan view, the aircraft 100 around which at-risk areas have been determined, according to one embodiment. In one example, for the at-risk areas from a hazard of an explosive atmosphere, the size of the at-risk areas can be adapted on the basis of the concentration of dihydrogen in the atmosphere and/or on the basis of the weather conditions and/or on the basis of other information provided by the risk monitoring systems. Thus, a first area ZR1 is smaller than a second area ZR2.

Optionally, the determination system 101 adds a predetermined margin when determining the size of the at-risk areas. This predetermined margin depends on the airport regulations in force. In one example, for an explosive atmosphere hazard linked to the presence of dihydrogen in the atmosphere, the actual risk is one metre around the ventilation orifice of the aircraft 100, but aviation regulations require that a margin of one additional metre be added. The determination system 101 therefore adds this predetermined margin when determining the size of the at-risk areas.

According to one embodiment, if there is no at-risk area determined by the determination system 101, the absence of at-risk areas must be confirmed by the determination system 101 to the personnel operating around and/or on the aircraft 100 via dedicated equipment, such as a laser emitter and/or a sound warning device.

According to one embodiment, the determination system 101 requests confirmation of the determination of the at-risk areas around the aircraft 100 to the flight personnel or to the ground personnel. This confirmation request is made, for example, via the human-machine interface of the cockpit or of the ground control centre.

According to one embodiment, in the event of the absence of first information which is representative of elements which are sources of risk from the risk monitoring systems SYS_S1, SYS_S2, SYS_S3, the determination system 101 determines the at-risk areas corresponding to a situation which is the worst conceivable situation in order to prevent all the risks and to identify all the possible at-risk areas in all the possible locations. This is the case, for example, when the determination system 101 is no longer in communication with the risk monitoring systems SYS_S1, SYS_S2, SYS_S3.

During a step 404, the determination system 101 transmits the information concerning the location and, where applicable, the size of the identified at-risk areas to equipment on board the aircraft 100 and/or ground support equipment) in order to indicate these at-risk areas via visual and/or sound markers.

Such equipment is, for example: laser emitters, photonic radars, sound warning devices etc.

It is thus possible to alert the personnel operating around and/or on the aircraft 100 during ground operations to the presence of at-risk areas. Advantageously, it is possible to highlight at-risk areas for which it is necessary to have specific clearance or certifications, according to the regulations in force.

According to one embodiment, the identified at-risk areas are displayed on the ground using laser emitters indicating to personnel the presence of the at-risk areas around the aircraft 100. These laser emitters can be on board the aircraft 100. They are, for example, distributed along the aircraft 100 in order to be able to cover all the possible at-risk areas around the aircraft 100. The number and the position of the laser emitters within the aircraft 100 depend on the type of risk and on the origin of this risk on the aircraft 100.

Alternatively or additionally, the laser emitters are positioned on the ground around the aircraft 100 as ground support equipment by operators. This ground support equipment is in communication with the determination system 101 of the aircraft 100 in order to indicate the one or more at-risk areas.

Thus, it is possible to indicate, using visual indicators, the location and the size of the at-risk areas around the aircraft 100. In particular, it is possible to identify where the at-risk areas begin via the projection of lines on the ground using laser emitters. It is possible to warn the personnel of the at-risk areas they can go to if they are qualified and possess the appropriate equipment or, on the contrary, the at-risk areas to avoid.

According to another embodiment, photonic radars can be used in addition to or independently of laser emitters. The use of photonic radars makes it possible to detect any unauthorized and/or unexpected entry into the at-risk areas.

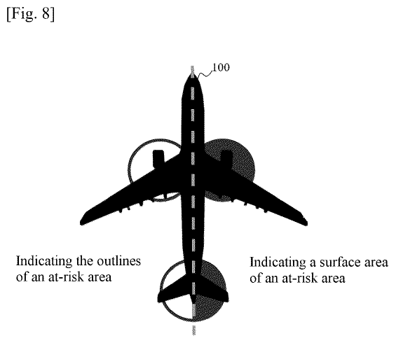

FIG. 7 schematically illustrates, in plan view, an aircraft around which at-risk areas have been identified, according to another embodiment. According to FIG. 7, photonic radars are used in addition to or independently of laser emitters. The laser emitters make it possible to indicate, by means of a visual indicator, such as a laser line on the ground, the various at-risk areas ZR1 to ZR3. The photonic radars scan the inside of these at-risk areas in order to detect any unauthorized or unexpected entry into these at-risk areas ZR1 to ZR3. When an unauthorized or unexpected entry is detected by a photonic radar, an alarm is transmitted to the cockpit of the aircraft 100 and to all the ground personnel.

The photonic radars can be installed on board the aircraft 100 or be used as ground support equipment. Advantageously, the use of the photonic radars is possible in difficult environmental conditions such as fog, dust, rain, etc.

In one embodiment, sound warning devices can be used to communicate with all ground personnel outside the aircraft 100. The sound warning devices can be used in addition to the laser emitters.

In one example of a use, the sound warning devices are used to warn the ground personnel in the event of a modification of the size and/or location of the at-risk areas. In another example of a use, the sound warning devices are used to warn the ground personnel of major problems and/or in the event of a need for communication with the cockpit or the risk monitoring systems SYS_S1, SYS_S2, SYS_S3.

Sound warning devices can also be used in addition to the use of photonic radar to prevent unauthorized and/or unexpected entry into an at-risk area.

FIG. 8 schematically illustrates, in plan view, an aircraft around which at-risk areas have been identified, according to another embodiment. According to the embodiment of FIG. 8, at-risk areas can be indicated:
either by indicating the outlines or edges of the at-risk areas (see left-hand part of the aircraft 100);
or by indicating a surface area corresponding to the complete at-risk area (see right-hand part of the aircraft 100).

1. A method for determining at least one at-risk area in an area around an aircraft during an execution of ground operations around and/or on the aircraft, the risk corresponding to a risk of hazard, inside said at-risk area, for personnel operating around and/or on the aircraft,
said method being executed by an at-risk area determination system comprising electronic circuitry, configured to: upon receipt of a request to determine at least one at-risk area:
obtain first information which is representative of at least one element which is a source of at least one risk,
obtain operational context information which is representative of an operational context of the aircraft during said ground operations,
determine, on the basis of said first information and said operational context information, said at-risk area and a location of said at least one at-at-risk area;
transmit said location of said at least one at-risk area in order to indicate a presence of said at least one at-risk area in said determined location to personnel operating on and/or around the aircraft during said ground operations.

2. The determination method according to claim 1, wherein
the risk corresponds to at least one risk among:
a risk associated with a hazard of an explosive atmosphere linked to the kerosene vapours or to the presence of dihydrogen in the atmosphere;
a risk associated with a “mechanical” hazard linked to the actuation of the movable elements of the aircraft such as a landing gear or a thrust reversal system;
a risk associated with an “engine” hazard linked to a phenomenon of jet blast or ingestion around intake;
a risk associated with an “electrical” hazard linked with an electrical phenomenon around the aircraft.

3. The determination method according to claim 1, wherein said operational context information is obtained on the basis of a selection from a list of operational scenarios comprising at least one scenario.

4. The determination method according to claim 1, wherein said request to determine said at least one at-risk area originates from:
a human-machine interface of a cockpit of said aircraft,
a human-machine interface which is integrated into the aircraft and can be accessed through a hatch made in the fuselage of the aircraft, or
a human-machine interface of a control centre.

5. The determination method according to claim 4, further comprising: receiving confirmation of the determination of said at least one at-risk area from: the human-machine interface of the cockpit of the aircraft, the human-machine interface which is integrated into the aircraft and can be accessed through the hatch, or the human-machine interface of the control centre.

6. The determination method according to claim 1, wherein transmitting said location of said at least one at-risk area comprises: transmitting said determined location to equipment on board the aircraft and/or ground support equipment.

7. The determination method according to claim 6, wherein the equipment on board the aircraft and the ground support equipment are chosen from:
laser emitters,
photonic radars, and
sound warning devices.

8. The determination method according to claim 6, further comprising: said equipment on board the aircraft and/or the ground support equipment displaying an outline of said at least one at-risk area, or a surface area of said at least one at-risk area.

9. A system for determining at least one at-risk area in an area around an aircraft during an execution of ground operations around and/or on the aircraft, the risk corresponding to a risk of hazard, inside said at-risk area, for personnel operating around and/or on the aircraft,
said at-risk area determination system comprising electronic circuitry, configured to: upon receipt of a request to determine at least one at-risk area:
obtain first information which is representative of at least one element which is a source of at least one risk,
obtain operational context information which is representative of an operational context of the aircraft during said ground operations,
determine, on the basis of said first information and said operational context information, said at-risk area and a location of said at least one at-risk area;
transmit said location of said at least one at-risk area in order to indicate a presence of said at least one at-risk area in said determined location to personnel operating on and/or around the aircraft during said ground operations.

10. An aircraft comprising an at-risk area determination system according to claim 9.

11. (canceled)

12. A non-transitory storage medium, storing a computer program comprising instructions causing the method according to claim 1 to be executed by a processor when said instructions are read and executed by the processor.
